(19) United States
(12) Patent Application Publication
(10) Pub. No.: US 2016/0351914 A1
(43) Pub. Date: Dec. 1, 2016

(54) METHOD FOR PREPARING A FUEL CELL ELECTRODE MEMBRANE ASSEMBLY BY MEANS OF ELECTRODEPOSITION

(71) Applicant: COMMISSARIAT A L'ENERGIE ATOMIQUE ET AUX ENERGIES ALTERNATIVES, Paris (FR)

(72) Inventor: Frédéric FOUDA-ONANA, Le Moule (GP)

(21) Appl. No.: 15/110,435

(22) PCT Filed: Jan. 20, 2015
(86) PCT No.: PCT/FR2015/050137

§ 371 Date: Jul. 8, 2016

(30) Foreign Application Priority Data
Feb. 18, 2014 (FR) 1451300

(51) Int. Cl. H01M 4/88; C25D 15/00; H01M 4/92; C25D 5/56; C25D 3/50

(52) U.S. Cl. CPC H01M 4/881; C25D 5/56; C25D 3/50; H01M 4/885; H01M 4/8853; H01M 4/92; C25D 15/00

(57) ABSTRACT

A method of preparing by electrodeposition a membrane electrode assembly for a fuel cell, including the steps of:
depositing a composition containing at least one precursor of a transition metal and electronically-conductive particles, on a main surface of a proton exchange membrane;
drying the deposit;
positioning the proton exchange membrane in an electrodeposition cell;
reducing the transition metal precursor made of transition metal particles having a degree of oxidation equal to 0, by flowing of an electric current through the electrodeposition cell;
obtaining a membrane electrode assembly having its proton exchange membrane including a main surface containing particles of the transition metal having a degree of oxidation equal to 0.

### DOMAIN THE INVENTION

The invention relates to a method of preparing by electrodeposition a membrane electrode assembly for a fuel cell, the membrane being a proton exchange membrane.

The field of use of the present invention more particularly relates to the conversion of chemical energy into electric energy and in the form of heat.

### BACKGROUND

Fuel cells, and particularly PEMFCs (proton exchange membrane fuel cells), are relatively attractive due to their high theoretical efficiency and to the non-polluting nature of the reaction byproducts.

Generally, a fuel cell comprises a MEA (membrane electrode assembly) such as that illustrated in FIG. 1. The proton exchange membrane (12) is in contact with a cathode and an anode hosting the reactions ensuring the cell operation, that is, the reduction of the oxidizer (oxygen, air) and the oxidation of the fuel (hydrogen, methanol . . . ), respectively.

The electrodes (cathode and anode) are generally formed of a catalytic layer (15, 16) allowing the oxidation-reduction reactions, and of a porous layer (13, 14) allowing the diffusion of the reactants and of the electrons.

The proton exchange membrane (12) ensures the passage of the protons formed during the reduction of the fuel between the anode and the cathode. However, it is not electronically-conductive. An external circuit ensures the passage of the electrons formed at the anode to the cathode where they are recombined with the protons to form water in the presence of oxygen.

The electrode materials allowing the oxidation-reduction reactions are generally made of carbon nanoparticles combined with nanoparticles of noble metals (Pt, Pd) or of alloys of metals Pt—X (X=Cu, Ni, Cr, Mn, . . . ).

Typically, a MEA is formed by hot pressing of two porous electrodes on the two main surfaces of a membrane. The electrodes further contain a catalytic layer (electrode material).

The deposition of the catalytic layer may in particular be performed by CCM or by CCB. The CCM (“Catalyst Coated Membrane”) technique comprises depositing an electrode ink on the membrane. However, the CCB (“Catalyst Coated Backing”) technique comprises depositing an electrode ink on a porous support such as a gas diffusion electrode.

To optimize the utilization rate of particles of noble metals (electrode material), and thus decrease the used quantity, a plurality of solutions have been developed:
the electrode material may be made of particles of an alloy based on noble metal. However, this type of catalytic layer is prepared chemically, which has as a main disadvantage a lack of homogeneity of the particle distribution;
the nanostructuring of the electrode material, which enables to increase the surface area of the electrode material accessible to the reactants (O₂, electrons, protons). The electrode material may then appear in the form of nanospheres, of core-shell particles, or of nanowires, for example. However, such structures are relatively complex to prepare, which makes them improper for commercialization for the time being;
the electrodeposition of platinum particles. However, this method is limited to the electrodeposition of platinum on a carbon gas diffusion electrode (CCB method), by reduction of a platinum solution.

Prior art methods thus have certain disadvantages that the present invention provides solving by simultaneously improving:
the distribution of catalytic particles in areas accessible to electrons and to ions, and
the active layer/membrane interface.

### SUMMARY OF THE DISCLOSURE

The Applicant has developed an electrode material deposition method enabling to optimize the different techniques of prior art.

This method implements an electrodeposition cell using the ion conductivity of a proton exchange membrane while prior art methods use the electronic conductivity of a gas diffusion electrode.

More specifically, the present invention relates to a method of preparing a membrane electrode assembly by electrodeposition, comprising the steps of:
depositing a composition containing at least one precursor (or complex) of a transition metal and electronically-conductive particles, on a main surface of a proton exchange membrane;
drying the deposit;
positioning the proton exchange membrane in an electrodeposition cell;
reducing the precursor of a transition metal made of transition metal particles having a degree of oxidation equal to 0, by flowing of an electric current through the electrodeposition cell;
obtaining a membrane electrode assembly having its proton exchange membrane comprising a main surface containing particles of the transition metal having a degree of oxidation equal to 0.

The electronically-conductive particles may in particular be carbon black, carbon nanotubes, or doped metal oxides.

Generally, the composition comprising the transition metal precursor may be deposited by different printing methods such as coating or more preferably spraying.

The deposit thus obtained is advantageously dried during the deposition phase. When the drying is thus performed simultaneously to the deposition, it is preferably implemented by positioning the proton exchange membrane on a substrate which may in particular be made of glass. The drying of the deposit is advantageously performed on a heating plate, the substrate on which the membrane is deposited being in contact with the heating plate.

According to a specific embodiment, the drying may also be carried out in an oven.

Advantageously, the membrane is dried at a temperature in the range from 60 to 80° C., whatever the drying method, simultaneously to the deposition or not.

It will be within the abilities of those skilled in the art to adapt the deposit drying methods and the drying time, which may in particular be at least equal to the duration necessary to perform the deposition.

“Membrane electrode assembly” means a MEA, that is, a membrane having each of its two main surfaces associated with an electrode, or a half-MEA, that is, a membrane having only one main surface associated with an electrode.

Thus, and conversely to prior art electrodeposition methods, a composition based on transition metal is deposited on a proton exchange membrane before an electro-chemical reduction step. The membrane allows a proton exchange, but it is not electronically-conductive, unlike prior art carbon substrates.

Typically, the proton exchange membrane may be made of a material selected from the group comprising perfluorosulfonic acid polymers such as Nafion® and Aquivion®.

The proton exchange membrane may be hydrated on implementation of the method.

On the other hand, the transition metal precursor may advantageously be selected from the group comprising noble metals of platinum, palladium, iridium type, metals alloys such as Pt—X, Pd—X, or Ir—X (X=Cu, Ni, Cr, Mn, Co . . . ).

It may in particular be a compound selected from the group comprising H₂[Pt(OH)₆]; H₂[Pt(NO₂)₂SO₄]; (NO₂)₂[Pt(NH₃)₄]; H₂[PtCl₆]; and mixtures thereof.

According to a specific embodiment, the transition metal precursor used is advantageously anionic and halogen-free. Advantageously, it is anionic and its counter-ion is not an alkaline or an alkaline earth.

Anionic precursors are preferred to avoid a possibly contamination of the membrane by exchanges between protons and cations of the transition metal.

The precursor of a transition metal is advantageously a platinum compound.

The reduction of the transition metal precursor is advantageously performed at a potential (applied between the two electrodes of the electrodeposition cell) which is preferably smaller than 0.7 volts.

Anyway, and according to a specific embodiment (platinum precursor, in particular), the potential window is advantageously between −0.2 and 1.1 volt, and more advantageously between −0.2 and 0.5 volt. The upper limit of 0.5 V enables to avoid the oxidation of the transition metal at the 0 oxidation degree (Pt(0) for example) into metal oxide (PtO for example). The lower limit, at −0.2 V, corresponds to a sufficiently high overvoltage to allow the H₂ generation reaction, without for the latter to be excessive. It will be within the abilities of those skilled in the art to adapt the potential range according to the precursor of a transition metal if necessary.

The reduction step is carried out by application of a specific signal which may be a pulsed or sweep voltage signal, or a pulsed or sweep current signal.

The reduction of the ions of transition metal M into M(0) (for example, Pt into Pt(0)) is measured either by applying a potential lower than equilibrium potential Mⁿ⁺/M (for example, Pt^{4 +}/Pt) or by applying a reduction current (negative current) which enables to decrease the degree of oxidation of M (for example, Pt(IV)) to degree 0.

For industrial reasons, the galvanic method is privileged given that the industry implements many electrochemical methods based on galvanic methods, such as electroplating, for example.

The potential cycling method enables to make sure by observation of curves of E vs. i that the reduction of the ions of transition metal M (for example, Pt), and thus the presence of particles of metal M at the membrane surface, is effective.

At the end of the reduction step, the size of the particles of metal M is advantageously in the nanometer range. It may in particular be in the range from 4 to 5 nm.

It will be within the abilities of those skilled in the art to adjust the nature and the intensity of the electric current to ascertain that the precursor of a transition metal is totally reduced. Indeed, the number of necessary electrons is directly proportional to the quantity of deposited metal.

Typically, the composition containing at least one precursor of a transition metal may also comprise at least one additive selected from the group comprising:
an ionomer (Nafion® for example), which especially allows proton exchange;
a solvent (isopropanol or water, for example), which especially allows the dispersion of electronically-conductive particles, and the dissolution of the precursor of the transition metal used; and
a humectant (glycerol or ethylene glycol, for example), which especially ensures a good wettability at the surface of the deposit. It generally has a high boiling temperature, and enables to keep water in the active layer, which favors the ion transport through the deposit during the reduction of the transition metal precursor.

The reduction of the transition metal precursor into particles of metal with a 0 oxidation state (metal 0) is carried out on the electronically-conductive particles.

The presence of electronically-conductive particles in the composition containing a transition metal precursor especially enables to increase the developed area without for all this sealing or clogging the accessibility to the membrane.

Conversely to prior art methods where the particles of metal 0 are prepared ex situ, all or almost all the deposited metal is available and active as a catalyst, given that it is both in contact with the membrane and with the electronically-conductive particles. Indeed, in the absence of this contact, there could be no reduction of the metal into metal 0.

It will be within the abilities of those skilled in the art to adapt the proportions of the different components of the composition. Generally, the ink composition has a dry extract which may be between 0.5 and 20 wt. %.

As an example, the deposited ink composition may advantageously comprise, before the deposition (advantageously by spraying), by weight for 100 parts by weight of the composition:
from 1 to 3 parts of transition metal precursor;
1 part of electronically-conductive particles;
15 parts of a solution of an ionomer, advantageously in the form of a dispersion;
0.1 part of humectant;
80 parts of solvent.

The quantity of transition metal precursor especially depends on the desired M/PEC weight ratio, PEC designating the electronically-conductive particles, and M the transition metal at degree 0. Generally, the ratio may be in the range from 10 to 50 by weight.

Thus, according to a very specific embodiment and as an example, the ink composition may comprise, apart from the transition metal precursor:
100 mg of carbon black (such as that commercialized under trade name Vulcan® CX-72);
1.3 mg of Nafion® in the form of a dispersion (such as that corresponding to grade D521 at 5 wt %);
8.5 ml of solvent (isopropanol, for example);
40 μl of humectant (glycerol for example).

Further, the main surface of the proton exchange membrane having the composition deposited thereon advantageously comprises from 50 to 500 μgₘₑₜₐₗ/cm² (by cm² of the main surface area of the membrane) at the end of the reduction step, the metal advantageously being platinum. The quantity of precursor is adjusted according to the final transition metal loading desired at the membrane surface.

For example, when the final platinum loading (at the end of the reduction step) is in the range from 50 to 500 μg_{Pt}/cm², the initial Pt(IV) loading is advantageously in the range from 130 to 1,300 μg/cm² for the H₂PtCl₆ precursor.

When the transition metal precursor comprises halogens, the MEA or half-MEA may be submitted to a post-treatment. For example, the halogenated ions may be eliminated by oxidation. It may in particular be the oxidation of ions Cl⁻ into Cl₂, for example by submitting the electrode to a potential cycling advantageously in the range from 50 mV to 1.4 V at 100 mV/s for from 20 to 30 cycles

According to a specific embodiment, the above-described method may be implemented on a half-MEA to form a MEA. Thus, the above-described steps (deposition of the composition of transition metal, drying, reduction) are carried out on the main surface of a membrane having one main surface deprived of particles of metal 0, and having its other main surface already comprising particles of a transition metal. In other words, the main surface of the proton exchange membrane, opposite to the main surface having the deposition performed thereon (advantageously by spraying), comprises transition metal particles having a degree of oxidation equal to 0, and this, prior to the deposition.

The half-MEA involved may be obtained by the method according to the invention. The forming of a MEA then comprises performing a second deposition from a metal composition which may be identical to or different from that used to prepare the half-MEA.

The present invention also relates to the half MEA and the MEA capable of being obtained by the above-described method. It also aims at the fuel cell (PEMFC) comprising the half-MEA or the MEA.

The half-MEA or the MEA may also be used in a PEM (“Proton Exchange Membrane”) electrolyzer.

The invention and the resulting advantages will better appear from the following non-limiting drawings and examples, provided as an illustration of the invention.

### DESCRIPTION OF THE DRAWINGS

FIG. 1 illustrates the diagram of a conventional fuel cell.

FIG. 2 illustrates the diagram of the cell of active layer electrodeposition on a proton exchange membrane, used in the method according to the invention.

FIG. 3 illustrates the voltammograms of the H₂[PtCl₆] and [Pt(NH₃)₄(NO₂)₂] precursors.

FIG. 4a illustrates the electron scanning image of the metal particles of a half-MEA obtained according to the method according to the invention from H₂[PtCl₆].

FIG. 4b illustrates the electron scanning image of the metal particles of a half-MEA obtained according to the method according to the invention from [Pt(NH₃)₄(NO₂)₂].

FIG. 5a illustrates the voltammograms, under a nitrogen or oxygen atmosphere, of a half-MEA obtained according to the method according to the invention from H₂[PtCl₆].

FIG. 5b illustrates an enlarged view of the voltammograms of FIG. 5a).

### DETAILED DESCRIPTION

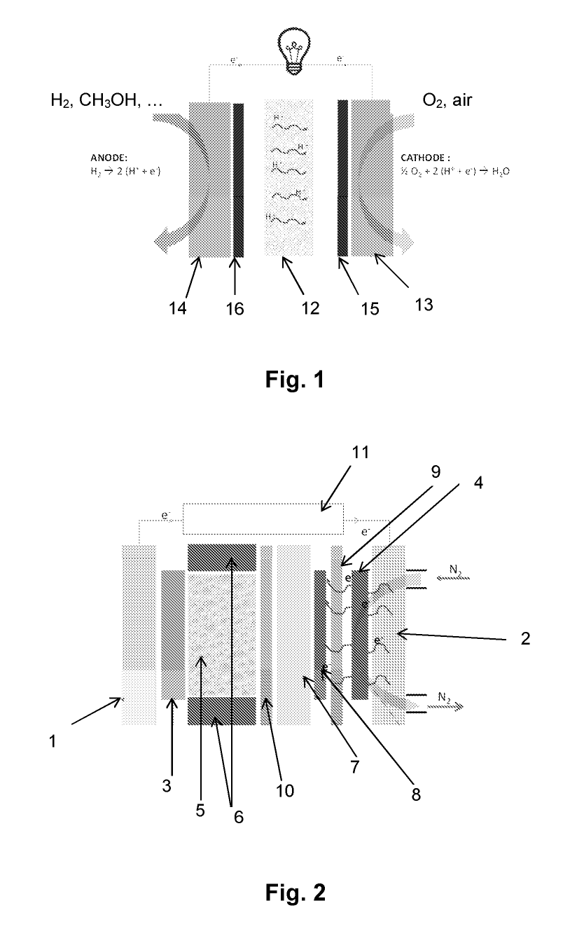

FIG. 2 illustrates an electrodeposition cell capable of allowing the implementation of the method according to the present invention.

This cell comprises:
a current or voltage generator (11),
two current collectors, (1) and (2),
an anode (3) (gate made of corrosion-resistant metal, of tantalum, for example),
a cathode (carbon, for example) (4),
an electrolyte (H₂SO₄) (5), arranged between the anode (3) and the cathode (4), in a cell closed, in particular, by seals (6).

Typically, anode (3) is porous, so that inert gas (nitrogen or argon, for example) can flow to avoid any oxygen reduction reaction at the anode (3).

In the method of forming a MEA or a half-MEA according to the present invention, a main surface of a proton exchange membrane (7) is covered with a composition of a transition metal salt, advantageously based on platinum.

The deposit (8) is dried during the deposition phase.

The proton exchange membrane (7) is then placed in the electrodeposition cell, between the cathode (4) and the electrolyte (5). To ensure the mechanical cohesion as well as the electronic conduction, the proton exchange membrane (7) is arranged between the two metal gates (9) and (10). The proton exchange membrane (7) is thus kept flat and in contact with gates (9) and (10).

In this device, anode (3) is in contact with the current collector (1) and the electrolyte (5). The metal gate (10) is in contact with the electrolyte (5) and the proton exchange membrane (7). The cathode (4) is in contact with the current collector (2) and the metal gate (9). Further, the metal gate (9) is also in contact with the transition metal precursor deposit (8) which is on a main surface of the proton exchange membrane (7).

The deposit (8) of metal such as platinum is in contact with the metal gate (9), that is, on the side of the cathode (4), to ensure the reduction of the metal into metal 0.

Since the proton exchange membrane (7) does not allow electron conduction, the deposit (8) cannot not be reduced if it is positioned on the side of the anode (3) of the electrodeposition cell. Indeed, the proton exchange membrane (7) would prevent the electrons from reaching the deposit (8).

The current or voltage generator (11) enables to ensure the reduction of the metal ions forming the deposit (7) by generating electrons and by conveying them to the cathode (4) of the electrodeposition cell.

The reduction of the metal ions of the deposit (8) enables to generate particles of metal 0 on the surface of the proton exchange membrane (7).

The proton exchange membrane (7) comprising this deposit of metal 0 corresponds to a half MEA.

A MEA with proton exchange membrane having on its two main surfaces a deposit of particles of metal 0 may be obtained from this half-MEA. The steps of the method according to the invention then have to be repeated on the main surface of the membrane comprising no particles of metal 0.

The second deposit may be formed from a metal composition which may be identical to or different from that implemented to prepare the half-MEA.

As already indicated, the reduction of the metal ions of the deposit (8) into particles of metal 0 is ensured by the electrons generated by the current or voltage generator (11).

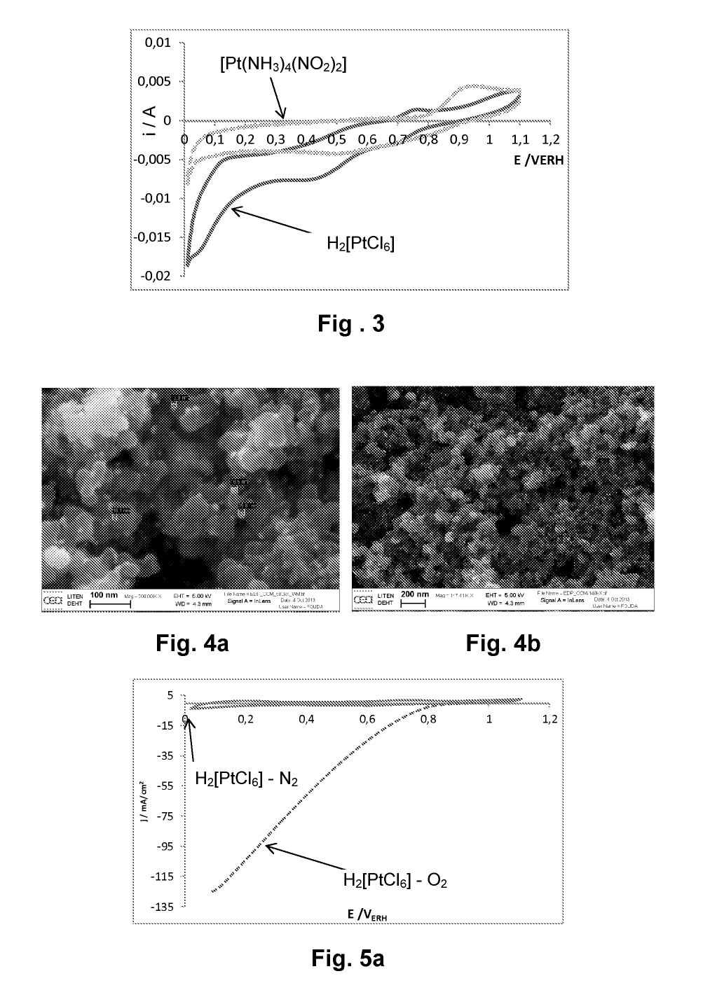

The potential applied between the electrodes (3) and (4) of the electrodeposition cell depends on the transition metal precursor used. For example, the redox potential of the PtCl₆²⁻/Pt couple is around 0.8 V_{ERH} (FIG. 3). Accordingly, the reduction of the PtCl₆²⁻ ion into platinum 0 requires a potential lower than 0.8 V_{ERH}.

It should also be noted that a potential lower than 0 V_{ERH} causes the reduction of protons H⁺ into hydrogen H₂. This reaction is also known to favor the dispersion of the particles of metal 0. It may thus be advantageous to apply a charge in coulombs at least from 5 to 10 times greater than the theoretical value to ensure that all Pt(IV) ions are reduced into Pt(0).

Thus, for each type of transition metal precursor used, it is necessary to determine the potential window when the reduction is performed by potential sweep. In the case of a current signal, this is not necessary, any reduction current can be envisaged.

Only the upper limit should be determined, given that the lower limit of this potential range is independent from the transition metal precursor used.

The electrode loading, that is, the quantity of metal particles can be easily deduced from the quantity of compound deposited on the membrane. For example, when 1 g of H₂[PtCl₆] (molar mass 409.81 g/mol) is deposited, this corresponds, after reduction of the platinum (molar mass 195 g/mol) to 0.475 g of platinum 0, that is, to a ratio H₂[PtCl₆]/Pt equal to 2.10 Similarly, ratio [Pt(NH₃)₄(NO₂)₂]/Pt is equal to 1.98.

### EMBODIMENTS OF THE INVENTION

A half-MEA has been prepared by implementation of the method according to the present invention. Its electrochemical behavior has been evaluated in ½ cell configuration.

### Forming of a Half-MEA According to the Invention from the H[PtCl₆] Precursor

A composition is prepared by mixing:
5 ml of a solvent made of the following mixture: 18 mL of isopropanol, 3 ml of Nafion® solution at 5 wt. % in isopropanol, and 90 μl of glycerol;
70 mg of carbon particles; and
80 mg of H₂[PtCl₆].

This composition (ink) is deposited by spraying on a main surface of a proton exchange membrane made of Nafion®.

The quantity of deposited ink is in the order of 1 mg/cm² on 25 cm² of the main surface of the membrane. It is dried during the deposition.

The membrane is then deposited between two metal gates (made of titanium, but they may advantageously be made of gold), in an electrodeposition cell especially comprising a tantalum anode, and a carbon cathode (FIG. 2).

The electrolyte of the electrodeposition cell is sulfuric acid, H₂SO₄, at 0.5M.

To reduce the H₂[PtCl₆] precursor and thus form particles of platinum 0, a deposition signal of cyclic voltammetry type is applied between the electrodes of the electrodeposition cell: 200 mV/s over 50 cycles in a potential window between −0.2 V_{ERH} and 0.5 V_{ERH} (ERH=reversible hydrogen electrode).

### Determination of the Working Potential for the H₂[PtCl₆] and [Pt(NH₃)₄(NO₂)₂] Precursors

As an example, the potential window for the H₂[PtCl₆] and [Pt(NH₃)₄(NO₂)₂] precursors has been determined (FIG. 3).

In this example, 20 mM of H₂[PtCl₆] and 20 mM of [Pt(NH₃)₄(NO₂)₂] have been dissolved in 0.5 M of H₂SO₄. By using a porous carbon electrode as a work electrode, and by scanning from 0 V_{ERH} to 1.1 V_{EHR}, the area where the platinum is reduced is identified. While for H₂[PtCl₆], the beginning of the reduction of the platinum salt is rather located towards 0.8 V_{ERH}, it is located towards 0.9 V_{ERH} for [Pt(NH₃)₄(NO₂)₂].

The two following reactions correspond to the reduction of the H₂[PtCl₆] precursor (FIG. 3):

PtCl₆²⁻+2 e⁻→PtCl₄²⁻+2 Cl⁻ E_{eq}=0.73 V_{ERH}

PtCl₄²⁻+2 e⁻→Pt+4 Cl⁻ E_{eq}=0.76 V_{ERH}

These two reactions correspond to the reduction waves between 0.7 V_{ERH} and 0.6 V_{ERH} and between 0.5 V_{ERH} and 0.4 V_{ERH} of the voltammograms of FIG. 3.

### Quantity of Platinum Deposited on the Membrane

Given the composition of the ink which has been deposited on the membrane, in 1 mg_{sec}/cm² of ink, there is 43 wt % of H₂[PtCl₆], which corresponds to 430 μg/cm² of platinum salt, and thus to 204 μg/cm² of platinum 0.

The deposited composition comprises 80 mg of H₂[PtCl₆], 70 mg of carbon particles, 38 mg of Nafion®, and 31.5 mg of glycerol. Since the glycerol is evaporated during the spray deposition, its weight is not taken into account to determine the quantity of deposited platinum.

### Forming of the Half MEA and Electrochemical Test of the Half-MEA Obtained from the H₂[PtCl₆] Precursor

After rinsing of the membrane electrode assembly thus obtained, 0.385 cm² of the half-MEA is placed in an electrochemical assembly of ½ cell type.

FIGS. 4a and 4b show the electronic scanning images of a half-MEA comprising Pt particles from 10 to 15 nm distributed at the surface of the carbon particles in areas where the electronic and ionic access is guaranteed. The half MEA is obtained from the H₂[PtCl₆] precursor.

The electrochemical characteristics of the half-MEA are evaluated in a ½ cell.

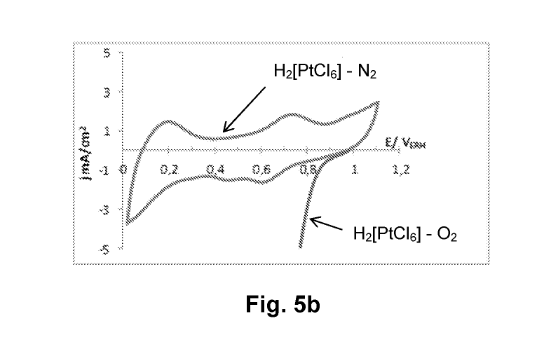

FIG. 5 shows the electrochemical signature of platinum 0, that is, a peak between 0.1 V_{ERH} et 0.3 V_{ERH} under a nitrogen atmosphere. This peak corresponds to the desorption/adsorption of hydrogen atoms at the surface of the Pt particles but also to the reactivity of Pt with oxygen since at 0.2 V_{ERH}, the intensity under oxygen is 60 times greater than under nitrogen.

1. A method of preparing by electrodeposition a membrane electrode assembly for a fuel cell, comprising the steps of:
depositing a composition containing at least one precursor of a transition metal and electronically-conductive particles, on a main surface of a proton exchange membrane;
drying the deposit;
positioning the proton exchange membrane in an electrodeposition cell;
reducing the transition metal precursor made of transition metal particles having a degree of oxidation equal to 0, by flowing of an electric current through the electrodeposition cell;
obtaining a membrane electrode assembly having its proton exchange membrane comprising a main surface containing particles of the transition metal having a degree of oxidation equal to 0.

2. The method of claim 1, wherein the proton exchange membrane is made of a material selected from the group comprising perfluorosulfonic acid polymers.

3. The method of claim 1, wherein the transition metal precursor is anionic and halogen-free.

4. The method of claim 1, wherein the transition metal precursor is selected from the group comprising H₂[Pt(OH)₆]; H₂[Pt(NO₂)₂SO₄]; (NO₂)₂[Pt(NH₃)₄]; H₂[PtCl₆]; and mixtures thereof.

5. The method of claim 1, wherein the reduction of the transition metal precursor is performed at a potential in the range from −0.2 to 1.1 volt.

6. The method of claim 1, wherein the composition containing at least one precursor of a transition metal also comprises at least one compound selected from the group comprising:
an ionomer;
a solvent; and
a humectant.

7. The method of claim 1, wherein the composition is deposited by spraying.

8. The method of claim 1, wherein the main surface of the proton exchange membrane having the composition deposited thereon comprises from 50 to 500 micrograms of transition metal per square centimeter at the end of the reduction step.

9. The method of claim 1, wherein the main surface of the proton exchange membrane, opposite to the main surface having the deposition performed thereon, comprises transition metal particles having a degree of oxidation equal to 0.

10. A fuel cell comprising the membrane electrode assembly capable of being obtained according to the method of claim 1.
